(19) United States
(12) Patent Application Publication
(10) Pub. No.: US 2026/0185611 A1
(43) Pub. Date: Jul. 2, 2026

(54) MECHANICAL SEAL ARRANGEMENT

(71) Applicant: EagleBurgmann Germany GmbH & Co. KG, Wolfratshausen (DE)

(72) Inventor: Klaus Lang, Eurasburg (DE)

(73) Assignee: EagleBurgmann Germany GmbH & Co. KG, Wolfratshausen (DE)

(21) Appl. No.: 19/127,564

(22) PCT Filed: Oct. 24, 2023
(86) PCT No.: PCT/EP2023/079599

§ 371 Date: May 6, 2025

(30) Foreign Application Priority Data
Nov. 17, 2022 (DE) 10 2022 130 415.9

(51) Int. Cl. F16J 15/36; F16J 15/34

(52) U.S. Cl. CPC F16J 15/363; F16J 15/3452

(57) ABSTRACT

The invention relates to a mechanical seal arrangement comprising a mechanical seal (2) having a rotating slide ring (3) and a stationary slide ring (4), wherein a sealing gap (5) is defined between a sliding surface (3a) of the rotating slide ring (3) and a sliding surface stationary (4a) of the slide ring (4), a combined preload and sealing device (6) for sealing and preloading one of the two slide rings in the axial direction (X-X), wherein the preload and sealing device (6) comprises a peripherally closed bellows (60) and a spring device (61), wherein the bellows (60) is configured as a secondary sealing element of the mechanical seal and provides sealing at one of the slide rings, wherein the bellows (60) exerts a first preload force F1 in a first axial direction X1, and wherein the spring device (61) exerts a second preload force F2 in a second axial direction X2, which is opposite the first axial direction X1, and wherein an absolute value of the first preload force F1 and the second preload force F2 is different, such that a resulting force FO of the preload and sealing device (6) acts, for preloading, in the direction of the slide rings (3, 4).

The invention relates to a mechanical seal arrangement having an improved preload device for preloading the mechanical seal for sealing media which are under high pressure, in particular above 200×10⁵ Pa, and are at high temperatures, in particular over 550° C.

Mechanical seal arrangements are known in various embodiments from the prior art. In this case, what are known as secondary sealing elements are used at a rear side of slide rings, which prevent leakage via the rear side of the slide rings. Such secondary sealing elements are for example O-rings or also bellows. However, the use of bellows is limited with respect to their intended purpose on account of external parameters of the mechanical seal arrangement, such as pressure, material strength, chemical resistance, and temperatures. In this case, bellows are used as dynamic secondary seals, in order in particular to allow axial displaceability of the mechanical seal. In order to seal high pressures and high temperatures, metal bellows can actually be used. However, metal bellows have very high rigidity, and therefore in particular the required axial mobility of the secondary seal can be achieved only with significant force variation.

The object of the present invention is therefore that of providing a mechanical seal arrangement which can provide an improved secondary sealing element while having a simple design and being simple and cost-effective to produce.

This object is achieved by a mechanical seal arrangement having the features of claim 1. The dependent claims disclose preferred developments of the invention.

In this case, the mechanical seal arrangement according to the invention according to claim 1 has the advantage that a bellows can be used as the secondary sealing element and this has significant freedom with respect to its properties, in particular regarding the material selection and with respect to its sealing properties. In this case, a preload of one of the slide rings is additionally achieved by a spring device. For this purpose, the mechanical seal arrangement of the invention comprises a mechanical seal having a rotating slide ring and a stationary slide ring which define a sealing gap between their sealing surfaces. Furthermore, a combined preload and sealing device is provided, for sealing and preloading one of the slide rings in the axial direction. The preload and sealing device comprises a peripherally-closed bellows and a spring device as a spring system. The bellows is configured as a secondary sealing element and has a sealing function, e.g. at a rear side of one of the slide rings. The bellows further has a first preload force F1 in a first axial direction X1, and the spring device has a second preload force in a second axial direction X2. In this case, the first and second axial direction are opposite one another, such that the preload forces of the bellows and the spring device are directed in different directions. In this case, an absolute value of the first and second preload force is different, such that a resulting force FO of the preload and sealing device always acts, for preloading, in the direction of the sealing gap of the mechanical seal. Thus, the preload forces of different magnitudes, which are directed in different directions, achieve the axial preload of the two slide rings of the mechanical seal.

Thus, in particular the bellows can be optimised with respect to its axial mobility, without constraints with respect to a preload force influencing the design too greatly when designing the bellows, since the additional spring device is still available for the preload force. Thus, with respect to the design of the bellows, more significant degrees of freedom result, which also allow for sealing of media under high pressure, in particular above 200×10⁵ Pa, and at high temperatures, in particular >550° C. This significantly increases the field of use of mechanical seal arrangements comprising bellows. In particular, such mechanical seal arrangements having combined preload and sealing devices can also be used in gas seals, for example in gas turbines or compressors of gas pipelines or the like.

Preferably, the value of the first preload force F1 of the bellows is always smaller than the value of the second preload force F2. As a result, on the one hand the bellows can be optimised with respect to its sealing, and on the other hand the desired preload force of the mechanical seal can be provided by a relatively simple design of the spring device.

The spring device is particularly preferably a spring element having a negative slope in the operating point A (negative spring) and preferably comprises at least one disc spring or at least one cylinder spring or another spring element which has a negative slope in the operating point A. However, the spring device can also comprise a plurality of disc springs, which are preferably each connected to one fold of the bellows.

Further preferably, the spring characteristic FK0 of the combined preload and sealing device has a maximum displacement range B of the mechanical seal, which defines a maximum axial displacement path of the mechanical seal. In said displacement range B, a maximum force variation of the resulting force is in a range of ±10% of a force Fx in the operating point A of the spring characteristic FK0. This ensures that the spring characteristic FK0 is as flat as possible in the region around the operating point A, and particularly preferably extends as flat as possible around the inflection point A.

Particularly preferably, the combined preload and sealing device is a premounted unit comprising the bellows and the spring device.

Particularly preferably, in this case, the spring device is fixed directly on the bellows. In the case of a metal bellows, for example the spring device can be fastened to the metal bellows by a welding process or a soldering process. In this case, the spring device is particularly preferably fixed on fold end regions of folds of the bellows.

According to an alternative embodiment of the invention, the spring device and the bellows are interconnected by means of a connection component. The connection component is preferably a ring disc, to which the spring device and the bellows are fastened together.

The connection component between the spring device and the bellows is further preferably a sleeve having a radially inwardly directed flange and a radially outwardly directed flange. In this case, the bellows is arranged on one of the flanges and the spring device on the other of the flanges. This allows for a very compact design, which can also be provided as a premounted unit.

Further preferably, the spring device is arranged outside of the bellows. Particularly preferably, in this case, the spring device is arranged entirely radially outside of the bellows.

According to an alternative embodiment of the invention, the spring device is arranged within the bellows. Particularly preferably, in this case, the spring device is arranged entirely radially within the bellows. This makes it possible for a particularly compact design of the mechanical seal arrangement to be achieved.

Preferably, the spring device is arranged such that the spring device is arranged outside of the medium to be sealed.

The mechanical seal arrangement is preferably a gas seal for sealing a gaseous medium. In this case, the gaseous medium is preferably CO₂ or natural gas.

Preferred embodiments of the invention are described in detail in the following, with reference to the accompanying drawings, in which:

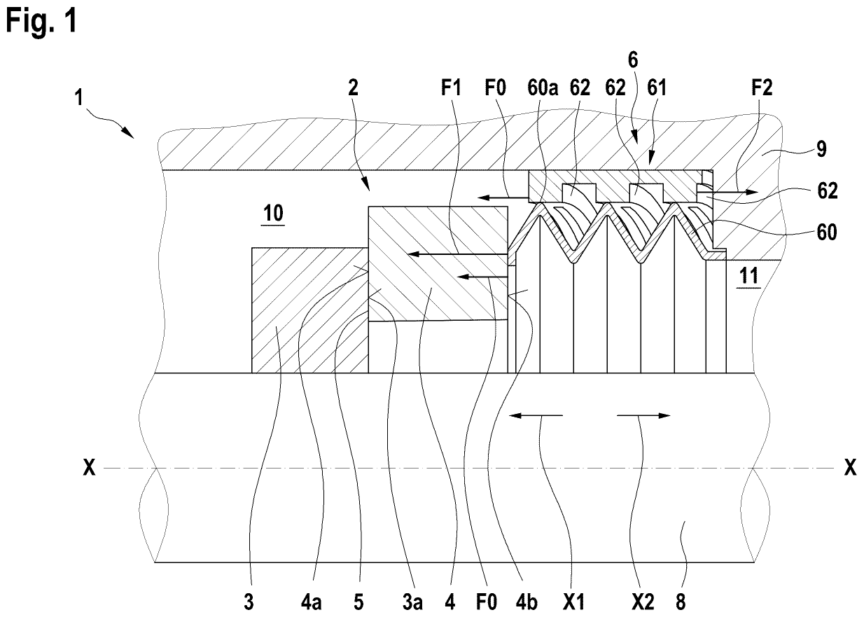

FIG. 1 is a schematic sectional view of a mechanical seal according to a first embodiment of the invention,

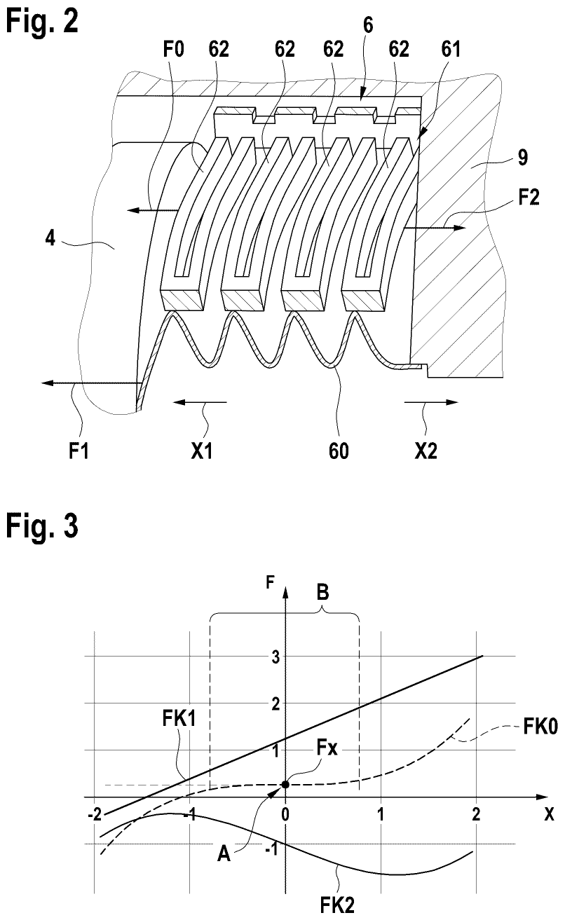

FIG. 2 is a schematic perspective view of a combined preload and sealing device of the mechanical seal arrangement of FIG. 1,

FIG. 3 is a schematic view of a graph of the spring force F over the path X for the spring characteristics of the combined preload and sealing device of FIG. 1,

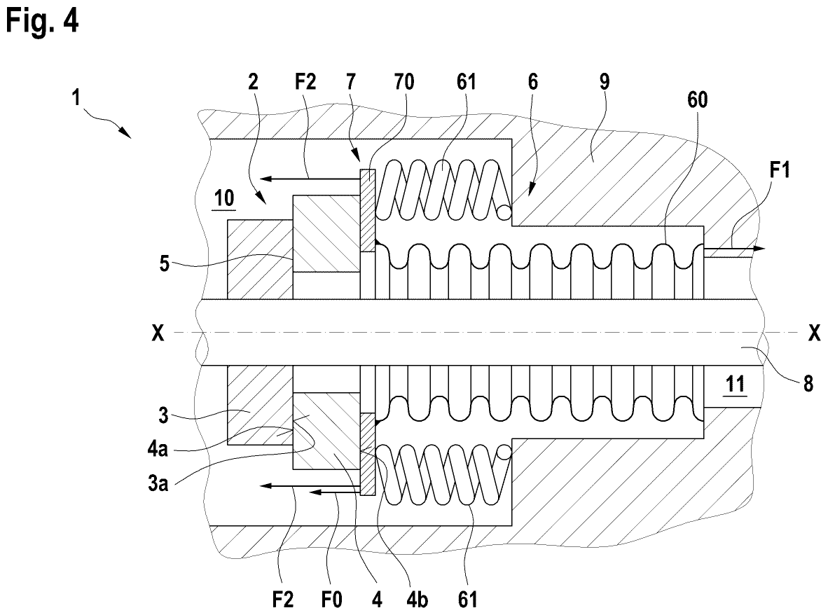

FIG. 4 is a schematic sectional view of a mechanical seal arrangement according to a second embodiment of the invention,

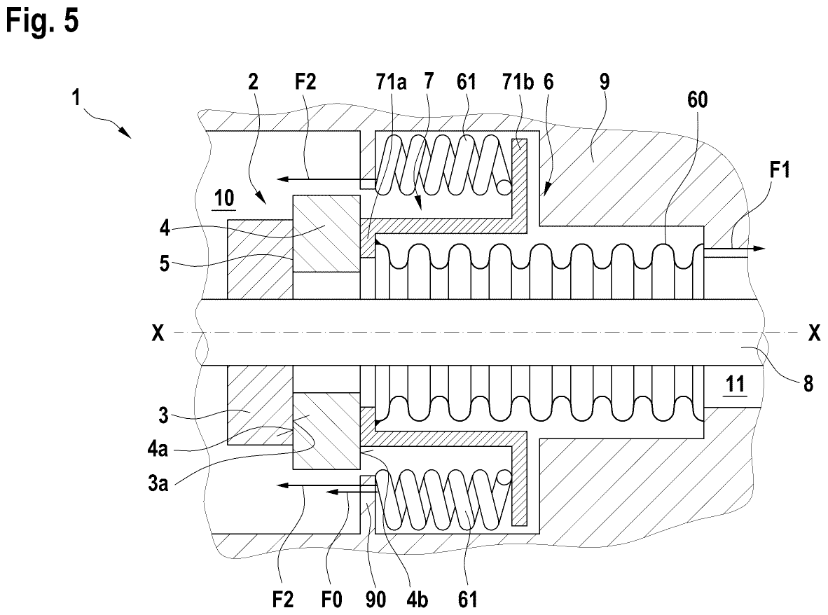

FIG. 5 is a schematic sectional view of a mechanical seal arrangement according to a third embodiment of the invention, and

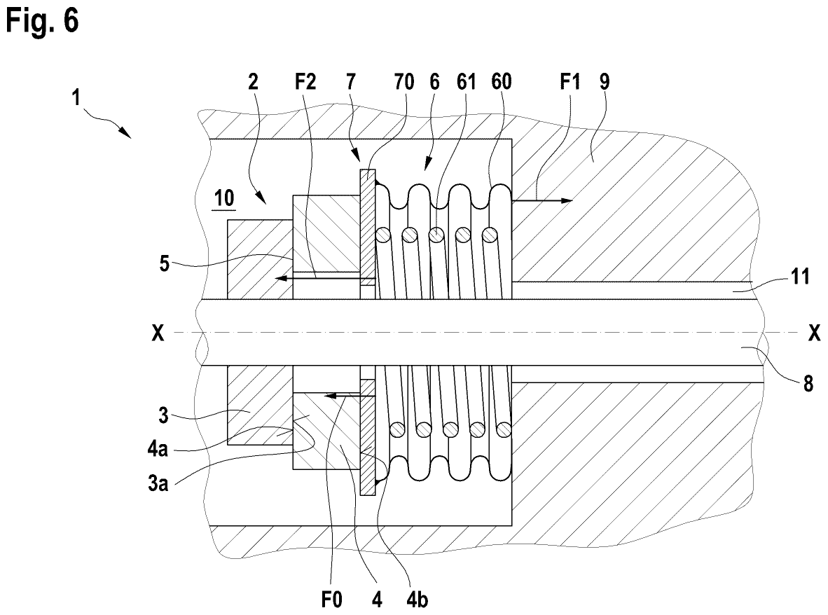

FIG. 6 is a schematic sectional view of a mechanical seal arrangement according to a fourth embodiment of the invention.

A mechanical seal arrangement 1 according to a first preferred embodiment of the invention is described in detail in the following with reference to FIG. 1 to 3.

As can be seen from FIG. 1, the mechanical seal arrangement 1 comprises a mechanical seal 2 having a rotating slide ring 3 and a stationary slide ring 4. A sealing gap 5 is defined between a sliding surface 3a of the rotating slide ring 3 and a sliding surface 4a of the stationary slide ring 4.

In this case, the mechanical seal arrangement 2 seals a product region 10 from an atmosphere region 11 at a shaft 8.

The mechanical seal arrangement 1 further comprises a combined preload and sealing device 6. The preload and sealing device 6 can be seen in detail from FIG. 2.

The combined preload and sealing device 6 comprises a bellows 60 and a spring device 61. The spring device 61 comprises a plurality of disc springs 62.

X-X denotes an axial direction of the mechanical seal arrangement 1.

The bellows 60 has a first preload force F1 in a first axial direction X1. The spring device 61 has a second preload force F2 in a second axial direction X2. As can be seen from FIGS. 1 and 2, the first and second axial direction X1, X2 are opposite in this case. Thus, the bellows 60, which is fixed in a rear side of the stationary slide ring 4, applies the first preload force F1 in the direction of the mechanical seal, and the second preload force F2 of the spring device 61 acts against this. In this case, the first preload force F1 is greater than the second preload force F2, in order to preload the sliding surfaces 3a, 4a in the direction towards one another, at the sealing gap 5.

The spring device 61 comprises a plurality of identical spring elements which are connected to one another. It is noted, however, that the individual spring elements 62 can also be fixed individually to the housing 9 and to the bellows 60. The spring elements 62 are configured as double disc springs extending in parallel and are guided annularly around the folds of the bellows 60. The spring elements 62 are in each case fixed at ends 60a of folds of the bellows 60.

Since, as a result, an absolute value of the first and second preload forces F1, F2 is different, a resulting preload force FO of the combined preload and sealing device 6 occurs, which acts in the direction towards the mechanical seal 2. In this case, the bellows 60 in particular undertakes the sealing of the product region 10 at the stationary slide ring 4, wherein the bellows 60 connects a rear side 4b of the stationary slide ring 4 to the housing 9.

The spring device 61 then compensates the first preload force F1 in part, on account of its smaller preload force F2.

The composition of the preload force FO of the mechanical seal 2 is shown again schematically in the graph of FIG. 3. In this case, FIG. 3 shows the spring force F over the path X. The line FK1 is the spring characteristic of the bellows 60, and the line FK2 is the spring characteristic of the spring device 61. In this case, the spring characteristic FK1 of the bellows is a straight line, and the spring characteristic FK2 of the spring device is sinusoidal. The sum of the two spring characteristics FK1 and FK2 gives the spring characteristic FK0 which defines the preload in the axial direction of the mechanical seal 2. In this case, in an operating point A the preload force on the mechanical seal 2 is positive and has the value Fx, such that the stationary slide ring 4 is pressed against the rotating slide ring 3. In this case, the spring device 61 is a spring element having a negative slope in the operating point A (negative spring).

As can furthermore be seen from FIG. 3, the combined spring characteristic FK0 of the preload and sealing device 6 around the operating point A is very flat. FIG. 3 shows a maximum displacement range B of the mechanical seal 2 around the operating point A. The maximum displacement range B defines a maximum axial displacement path of the mechanical seal 2. In this case, an axial displacement of components of the mechanical seal may occur during operation, due to pressure shocks or the like, wherein the sealing ability of the mechanical seal arrangement must nonetheless be ensured. In the maximum displacement range B of the mechanical seal, a maximum force variation of the resulting force of the two spring systems of bellows 60 and spring device 61 is now in a range of ±10% of the force Fx in the operating point A of the spring characteristic FK0 (cf. FIG. 3). This ensures an excellent axial mobility of the stationary slide ring 4, such that in particular shocks or the like, which, during operation, can cause an axial displacement of components of the mechanical seal arrangement, can be reliably contained and cushioned. Due to the flat spring characteristic FK0 in the region of the operating point A, after deflection has finished a quick return to the starting position shown in FIG. 1 is then possible. Thus, the combination of the two spring systems makes it possible to achieve a virtually horizontal spring characteristic FK0 of the combined preload and sealing device 6 at the operating point A.

The bellows 60 is preferably made of metal. This makes it possible for the mechanical seal arrangement 1 to be usable as a gas seal which can be used at very high temperatures >550° C. and very high pressures >200×10⁵ Pa.

In this way, the present invention allows for a mechanical seal arrangement which allows for bellows uses which were hitherto not possible in this way due to pressure, material strength, chemical compatibility, and/or temperatures. In particular when metal bellows are used, the invention can allow for a compensation of the mobility of rigid bellows by the additional integrated spring device 61. Furthermore, the mechanical seal arrangement 1 according to the invention can operate substantially in a wear-free manner and of course provides the necessary leak-tightness.

The spring device 61 is arranged entirely radially outside of the bellows 60. This allows for a particularly compact design. Furthermore, the combined preload and sealing device 6 can e provided as a premounted unit and be mounted on the mechanical seal arrangement 1 easily and without significant effort.

Further mechanical seal arrangements 1 will be described in the following FIG. 4 to 6, in which identical or functionally identical parts are denoted by the same reference signs as in the first embodiment.

FIG. 4 shows a mechanical seal arrangement 1 according to a second embodiment of the invention. The combined preload and sealing device 6 of the second embodiment additionally comprises a connection component 7, as well as the bellows 60 and the spring device 61. The connection component 7 connects the bellows 60 to the spring device 61. In this embodiment, the connection component 7 is a ring disc 70. As can be seen from FIG. 4, both an axial end of the bellows 60 and an axial end of the spring device 61 are arranged on the ring disc 70. Preferably, the bellows 60 and the spring device 61 are fixed to the ring disc 70 by means of welded joints. In this case the spring device 61 and the bellows 60 are supported at their other end on the housing 9.

Furthermore, in the second embodiment, the second preload force F2 is directed in the direction of the mechanical seal 2, and the first preload force F1 is directed in the direction away from the mechanical seal. In this case, the second preload force F2 is greater than the first preload force F1, such that the resulting combined preload force FO is present in the direction of the mechanical seal 2. In the second embodiment, the spring device comprises a plurality of smaller cylinder springs, which are arranged along the outer periphery of the bellows 60. In this case, the spring device 61 is arranged entirely radially outside of the bellows 60.

FIG. 5 shows a mechanical seal arrangement 1 according to a third embodiment of the invention. The third embodiment substantially corresponds to the second embodiment, wherein a connection component 7, which connects the bellows 60 to the spring device 61, is configured differently in the third embodiment. As shown in FIG. 5, the connection component 7 of the third embodiment is a sleeve 71 having a radially inwardly directed flange 71a and a radially outwardly directed flange 71b. In this case, the bellows 60 is fixed to the radially inwardly directed flange 71a. The spring device 61 is fixed to the radially outwardly directed flange 71b. This also achieves a very compact design, wherein the spring device 61 is arranged entirely radially outside of the bellows 60. In addition, a stop 90 is also provided on the housing 9, for supporting the spring device 61.

FIG. 6 shows a mechanical seal arrangement 1 according to a fourth embodiment of the invention. In contrast to the previous embodiments, in the fourth embodiment the spring device 61 is arranged entirely within the bellows 60. As in the two preceding embodiments, the combined preload and sealing device 6 also comprises a connection component 7, again provided as a ring disc 70, as well as the bellows 60 and the spring device 61. In this case, the spring device 61 and the bellows 60 are in each case fixed at one end to the ring disc 70. The other end of the bellows 60 and the spring device 61 is supported on the housing 9.

Regarding all the embodiments, it is noted that the force ratios of the preload forces F1, F2 of the combined preload and sealing device 6 can in each case also be reversed. That is to say that the first preload force F1 of the bellows 60 and the second preload force F2 of the spring device 61 can be selected as desired with respect to magnitude and direction, as long as a resulting preload force FO in the direction of the mechanical seal 2 is present. Furthermore, it is also possible for the bellows 60 to be produced from a flexible material, for example rubber or the like. In addition to disc springs, cylinder springs, which are arranged along a periphery around or in the bellows 60, can also be used as the spring device 61, or further alternatively a single cylinder spring which is arranged around or in the bellows 60.

### LIST OF REFERENCE SIGNS

1 mechanical seal arrangement
2 mechanical seal
3 rotating slide ring
3a sliding surface
4 stationary slide ring
4a sliding surface
4b rear side
5 sealing gap
6 combined preload and sealing device
7 connection component
8 shaft
9 housing
10 product region
11 atmosphere region
60 bellows
60a end of a fold of the bellows
61 spring device
62 spring elements
70 ring disc
71 sleeve
71a radially inwardly directed flange
71b radially outwardly directed flange
90 stop
A operating point of the preload and sealing device 6
B axial displacement range
F0 combined preload force
F1 first preload force of the bellows
F2 second preload force of the spring device
Fx force in the operating point
FK0 combined spring characteristic
FK1 spring characteristic of the bellows
FK2 spring characteristic of the spring device
X-X axial direction
X1 first axial direction
X2 second axial direction

1. Mechanical seal arrangement, comprising:
mechanical seal having a rotating slide ring and a stationary slide ring wherein a sealing gap is defined between a sliding surface of the rotating slide ring and a sliding surface of the stationary slide ring
combined preload and sealing device for sealing and preloading one of the two slide rings in the axial direction (X-X),
herein the preload and sealing device comprises a peripherally-closed bellows and a spring device,
herein the bellows is configured as a secondary sealing element of the mechanical seal and provides sealing at one of the slide rings,
herein the bellows exerts a first preload force F1 in a first axial direction X1, and wherein the spring device exerts a second preload force F2 in a second axial direction X2, which is opposite the first axial direction X1, and
herein an absolute value of the first preload force F1 and the second preload force F2 is different such that a resulting force F0 of the preload and sealing device acts, for preloading, in the direction of the slide rings.

2. Mechanical seal arrangement according to claim 1, wherein the value of the first preload force F1 of the bellows is smaller than the value of the second preload force F2 of the spring device.

3. Mechanical seal arrangement according to claim 1, wherein a spring characteristic FK0 of the preload and sealing device in an operating point A of the preload and sealing device describes an inflection point, wherein the spring device is a spring system having a negative slope in the operating point.

4. Mechanical seal arrangement according to claim 3, wherein the spring characteristic FK0 of the combined preload and sealing device is a maximum displacement range B of the mechanical seal which defines a maximum axial displacement path of the mechanical seal has a maximum force variation of the resulting force in a range of ±10% of a force Fx in the operating point A of the spring characteristic FK0.

5. Mechanical seal arrangement according to claim 1, wherein the preload and sealing device is a premounted unit, comprising the bellows and the spring device.

6. Mechanical seal arrangement according to claim 5, wherein the spring device is fixed directly on the bellows.

7. Mechanical seal arrangement according to claim 5, wherein the spring device is connected to the bellows by means of a connection component.

8. Mechanical seal arrangement according to claim 7, wherein the connection component is a ring disc or a sleeve having a radially inwardly directed flange and a radially outwardly directed flange.

9. Mechanical seal arrangement according to claim 1, wherein the spring device is arranged outside of the bellows.

10. Mechanical seal arrangement according to claim 9, wherein the spring device is arranged entirely radially outside of the bellows.

11. Mechanical seal arrangement according to claim 1, wherein the spring device is arranged within the bellows.

12. Mechanical seal arrangement according to claim 11, wherein the spring device is arranged entirely within the bellows.

13. Mechanical seal arrangement according to claim 1, which is configured as a gas seal.
